(19) United States
(12) Patent Application Publication
(10) Pub. No.: US 2013/0257910 A1
(43) Pub. Date: Oct. 3, 2013

(54) APPARATUS AND METHOD FOR LESION DIAGNOSIS

(71) Applicants: Moon-Ho PARK, Hwaseongsi (KR); Kyoung-Gu WOO, Seoul (KR)

(72) Inventors: Moon-Ho PARK, Hwaseongsi (KR); Kyoung-Gu WOO, Seoul (KR)

(73) Assignee: SAMSUNG ELECTRONICS CO., LTD., Suwon-si (KR)

(21) Appl. No.: 13/554,218

(22) Filed: Jul. 20, 2012

(30) Foreign Application Priority Data
Mar. 28, 2012 (KR) 10-2012-0031908

(51) Int. Cl. G09G 5/00; G06K 9/00

(52) U.S. Cl. 345/672; 382/128

(57) ABSTRACT

An apparatus and method for supporting lesion diagnosis are disclosed. An apparatus for facilitating lesion diagnosis includes: a candidate detection unit configured to detect one or more lesion candidate using a primary image of a body region, a calculation unit configured to calculate a movement path corresponding to a sequence for analyzing the one or more lesion candidate, and a control unit configured to request an additional image with respect to the one or more lesion candidate along the movement path.

### CROSS-REFERENCE TO RELATED APPLICATION

This application claims the benefit under 35 U.S.C. §119(a) of Korean Patent Application No. 10-2012-0031908, filed on Mar. 28, 2012, the disclosure of which is incorporated herein by reference in its entirety for all purposes.

### BACKGROUND

1. Field

The following description relates to diagnosis of a lesion, and for example, to an apparatus and method for facilitating lesion diagnosis.

2. Description of the Related Art

With the recent development of surgical instruments, a variety of minimally invasive is surgery techniques have emerged. A minimally invasive surgery is a procedure in which a lesion is approached and/or surgically operated on with surgical instruments such as a syringe, a catheter, a laparoscopic device and the like, without incising the skin and muscle in order to approach the lesion. A minimally invasive surgery may be used to perform a variety of surgical procedures, such as drug infusion, lesion removal, prosthesis insertion, and the like. To perform a minimally invasive surgery, a doctor or a physician may like to accurately discern a characteristic of the lesion, such as its size, shape, orientation, and the like, and to acquire information regarding the exact position of the lesion inside the body.

In general, the primary process by which a physician initially determines a lesion's position, shape, orientation, and the like involves acquiring an image of a region of the body to be examined using a medical imaging apparatus. Various kinds of the medical imaging apparatuses have been developed for diagnostic purposes. Examples of medical imaging apparatuses used for diagnosis include a computed tomography (CT) apparatus, a magnetic resonance imaging (MRI) apparatus, a positron emission tomography (PET) apparatus, a single photon emission CT (SPECT) apparatus, a diagnostic ultrasound imaging apparatus, and the like.

Among these imaging technologies, a lesion diagnosis using a diagnostic ultrasound imaging apparatus, such as, an ultrasonographic examination (ultrasound imaging), involves exposing a specific region of a human body to be examined with ultrasound waves, generating an image in accordance with a waveform of reflected ultrasound waves in order to detect a specific object inside the human body, such as a lesion, from the generated image.

An ultrasonographic examination typically involves first irradiating some portions of the specific region to be examined with ultrasound waves to acquire an image. The acquired image is then confirmed, and other regions of the body are examined when the confirmed image shows normal tissues or organs. In the event that an examinant such as a physician locates a specific region that may contain a lesion, a multi-planar reconstruction (MPR) image may be acquired with respect to the corresponding region. An MPR image is a three-dimensional (3D) image. Thereafter, the lesion or suspected lesion may be examined in detail using the acquired image. Alternatively, in the event that a two-dimensional (2D) ultrasound probe is used, the examinant may directly adjust an angle of the probe to perform the examination so that similar results as those acquired in analysis of a MPR image may be obtained.

However, a process of acquiring an MPR image is typically time-consuming. Therefore, an examination time may increase when multiple MPR images are taken. In addition, the MPR images are typically obtained just for the regions of the body that are suspected to contain a lesion based on the examinant's judgment. Therefore, misdiagnosis can result when the examinant overlooks a specific lesion due to carelessness, or the like.

### SUMMARY

In one general aspect, there is provided an apparatus for facilitating lesion diagnosis, the apparatus including: a candidate detection unit configured to detect one or more lesion candidate using a primary image of a body region, a calculation unit configured to calculate a movement path corresponding to a sequence for analyzing the one or more lesion candidate, and a control unit configured to request an additional image with respect to the one or more lesion candidate along the movement path.

The calculation unit may be configured to determine the movement path based on a malignancy level of each of the one or more lesion candidate.

The malignancy level may be calculated based on image shape information, image orientation information, image contour information, or image uniformity information of each of the one or more lesion candidate.

The calculation unit may be configured to determine the movement path so that a moving distance is shortest when acquiring the additional image.

The control unit may be configured to control the movement path to be displayed on a display unit.

The control unit may be configured to control the movement path so that lesion candidate related information including malignancy level information, malignancy level determination base information, visiting frequency information or a combination thereof is displayed on the display unit.

The additional image may be an improved image of the primary image.

The additional image may include a multi-planar reconstruction (MPR) image.

The additional image may further include either an image obtained by cutting a lesion candidate along a plane at an angle, or an image in which a focal point is aligned with a lesion candidate.

In another general aspect, there is provided a method of facilitating lesion diagnosis, the method involving: acquiring a primary image of a body region, detecting one or more lesion candidate using the primary image, calculating a movement path corresponding to a sequence for analyzing the lesion candidates, and requesting an additional image with respect to the lesion candidates along the movement path.

The calculating may involve determining the movement path based on a malignancy level of each of the one or more lesion candidate.

The malignancy level may be calculated based on image shape information, image orientation information, image contour information, or image uniformity information of each of the one or more lesion candidate.

The calculating may involve determining the movement path so that a moving distance is shortest when acquiring the additional image.

The method of facilitating lesion diagnosis may further involve controlling the movement path to be displayed on a display unit.

The controlling may include controlling the movement path so that lesion candidate related information including malignancy level information, malignancy level determination base information, visiting frequency information of the lesion candidate, or a combination thereof is displayed on the display unit.

The additional image may be an improved image of the primary image.

The additional image may include a multi-planar reconstruction (MPR) image.

The additional image may further include either an image obtained by cutting a lesion candidate along a plane of a selected angle, or an image in which a focal point is aligned with a lesion candidate.

In another general aspect, there is provided an apparatus for facilitating lesion diagnosis, the apparatus including: a processor configured to analyze an image of a body region, detect one or more lesion candidate from the image, and obtain an additional image of at least one of the one or more lesion candidate, and a display unit configured to display at least one of the one or more lesion candidate, wherein the processor is configured to perform an initial diagnosis of at least one of the one or more lesion candidate.

The processor may be configured to perform an initial diagnosis based on a degree to which the additional image has characteristics of an actual lesion.

The processor may be configured to perform an initial diagnosis of a tumor based on whether the additional image has characteristics exhibited by a malignant tumor, and, in an event that a lesion candidate is determined to include a tumor, the display unit is configured to display the lesion candidate corresponding to the tumor.

The processor may be configured to detect the one or more lesion candidate from the image of the body region based on a probability that a region contains a lesion based on statistical data.

The processor may be configured to calculate a movement path corresponding to a is sequence for analyzing the one or more lesion candidate and to obtain the additional image with respect to at least one of the one or more lesion candidate along the movement path.

Other features and aspects may be apparent from the following detailed description, the drawings, and the claims.

### BRIEF DESCRIPTION OF THE DRAWINGS

FIG. 1 is a diagram illustrating an example of a medical image diagnostic apparatus.

FIG. 2 is a diagram illustrating a configuration of an example apparatus for facilitating lesion diagnosis.

FIG. 3 is a graphical diagram illustrating an example of a movement path between a plurality of lesion candidates displayed on a display unit.

FIG. 4 is a diagram illustrating an example of a method of digitizing and displaying information about each of the plurality of lesion candidates of FIG. 3.

FIG. 5 is a graphical diagram illustrating another example of a movement path between a plurality of lesion candidates displayed on a display unit.

FIG. 6 is a diagram illustrating an example of a method of digitizing and displaying information about each of the plurality of lesion candidates of FIG. 5.

FIG. 7 is a flowchart illustrating an example of a method of facilitating lesion diagnosis.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a is comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Described in the following description are an apparatus and a method for facilitating lesion diagnosis that may improve accuracy of automatic lesion detection and primary diagnosis using a medical image diagnostic apparatus. Further described in the following description are an apparatus and a method for facilitating diagnosis of a lesion that may effectively and rapidly detect and diagnose a lesion using a medical image diagnostic apparatus.

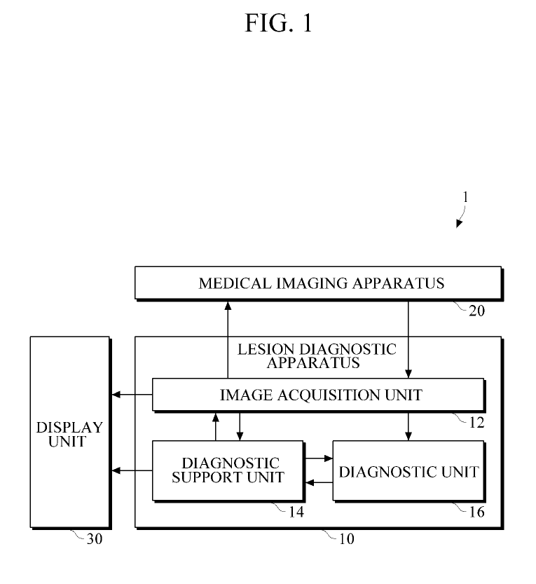

FIG. 1 is a diagram illustrating the configuration of an example of a medical image diagnostic apparatus. The medical image diagnostic apparatus 1 illustrated in FIG. 1 is an example of an apparatus that facilitates lesion diagnosis. An apparatus for facilitating lesion diagnosis may be adopted and used with a medical image diagnostic apparatus having a configuration that is different from that of the apparatus illustrated in FIG. 1.

Referring to FIG. 1, the illustrated medical image diagnostic apparatus 1 includes a lesion diagnostic apparatus 10, a medical imaging apparatus 20, and a display unit 30.

The medical imaging apparatus 20 is an imaging system that photographs an image of a specific region of a human body, and provides the lesion diagnostic apparatus 10 with an improved image (hereinafter referred to as “additional image”) of the specific region that is requested together with a 3-dimensional (3D) volume image of the entire diagnostic region. Here, a “3D volume image” is an example of an image that is primarily acquired with respect to the entire examined region for the purpose of lesion diagnosis, and there is no limitation on the type of 3D volume image that may be used as long as the 3D volume image is used to detect a is specific region that may include a lesion candidate for in which an additional image may be acquired.

The medical imaging apparatus 20 may be a medical imaging system (MIS) or a picture archiving and communication system (PACS). However, there is no limitation on the type of the medical imaging apparatus 20 that may be used, and different types of medical imaging technologies may be used in other examples. For example, the medical imaging apparatus 20 may include at least one of a computed tomography (CT) apparatus, a magnetic resonance imaging (MRI) apparatus, a positron emission tomography (PET) apparatus, a single photon emission CT (SPECT) apparatus, and diagnostic ultrasonographic imaging (ultrasound) equipment.

The display unit 30 may be a device for displaying an image photographed by the medical imaging apparatus 20 and other information that may be useful for diagnosis of the lesion to the user (examinant). The display unit 30 may display a variety of data and information that are acquired or generated during a diagnosis of lesion using the medical image diagnostic apparatus 1. The display unit may also display a 3D volume image and additional images that are photographed using the medical imaging apparatus 20.

According to an example, the display unit 30 may display a variety of information about lesion candidates that are generated by the lesion diagnostic apparatus 10, including, for example, position information, movement path information, malignancy level information, determination base information, visiting frequency information of each of the lesion candidates, and the like. The display unit 30 may also display a diagnostic result of a corresponding lesion candidate, and the like. For example, the display unit 30 may display more than a single image or a single piece of information. A photographed image and a variety of information that supplements the photographed image may be displayed together on the display unit 30, using a variety of display partitioning techniques. There is no limitation on the type or number of display units 30 that may be used. For example, there may be two or more display screens showing different photographed images.

The lesion diagnostic apparatus 10 is an apparatus for facilitating the diagnosis of lesions using an image photographed by a medical imaging apparatus 20. More specifically, the lesion diagnostic apparatus 10 may acquire a 3D volume image of a diagnostic region that is photographed by the medical imaging apparatus 20, detect lesion candidates using the obtained 3D volume image, and acquire an additional image through the medical imaging apparatus 20 with respect to each of the lesion candidates to thereby facilitate the diagnosis of the lesions. In this example, the lesion diagnostic apparatus 10 includes an image acquisition unit 12, a diagnostic support unit 14, and a diagnostic unit 15. Such classification with respect to components of the lesion diagnostic apparatus 10 is performed in a logical manner according to classification of functions, and the respective components may be physically separately implemented, or implemented in such a manner that at least two components are mutually integrated.

The image acquisition unit 12 is a device for acquiring images photographed by the medical imaging apparatus 20. As described above, the images photographed by the medical imaging apparatus 20 include a 3D volume image with respect to an entire specific region of a human body to be examined. The image acquisition unit 12 may transmit, to the medical imaging apparatus 20, an additional image photographing request with respect to each of lesion candidates detected in the diagnostic support unit 14 or each of lesion candidates that receive a request from the diagnostic support unit 14, and acquire the additional image photographed by the medical imaging apparatus 20 in response to the additional image photographing request.

In an example lesion diagnostic apparatus, the “additional image” indicates an image that is more concrete than the 3D volume image, such as an image depicting a planar view with is respect to various angles, or an image of a lesion candidate having an improved image quality. Accordingly, the “additional image” is not limited to a multi-planar reconstruction (MPR) image for the lesion candidate, and may also include an image having an improved image quality with respect to a specific region, such as a lesion candidate, that is acquired using auto-focusing, and the like. The additional image may also include an image depicting a planar view with a predetermined angle that is acquired by an examinant operating a 2D ultrasound probe at a specific angle. The 3D volume image and the additional image acquired by the image acquisition unit 12 may be transmitted to the display unit 30 to thereby be displayed on a screen, and also transmitted to the diagnostic support unit 14 and a diagnostic unit 16 to thereby be used in lesion diagnosis.

The diagnostic support unit 14 is a device for facilitating lesion diagnosis in the diagnostic unit 16. The diagnostic support unit 14 first detects lesion candidates using the 3D volume image acquired by the image acquisition unit 12, and provides a movement path so that the diagnostic unit 16 can sequentially perform diagnostic analysis with respect to the detected lesion candidates. The diagnostic support unit 14 may calculate a malignancy level and the like of each of the detected lesion candidates, and provide position information and determination base information about a corresponding lesion candidate and the like to the diagnostic unit 16.

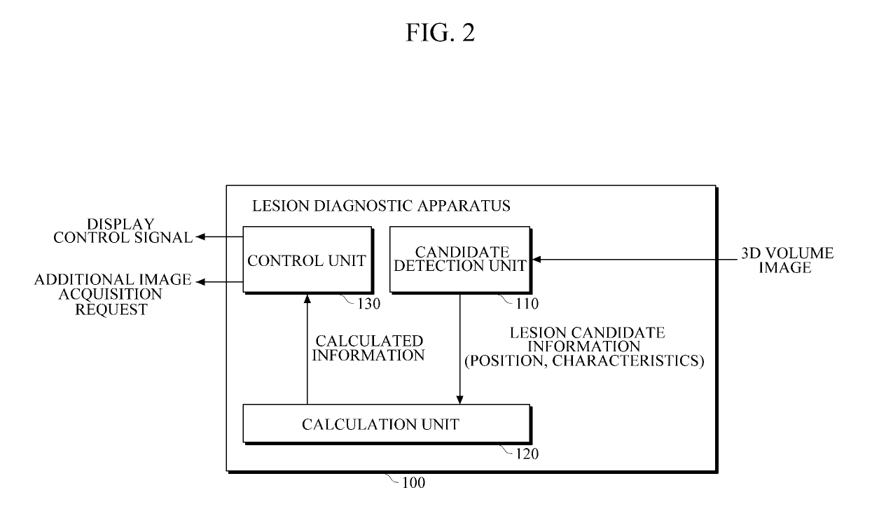

The information provided to the diagnostic unit 16, such as, for example, movement path information between the lesion candidates, and position information, determination base information, visiting frequency information, diagnostic result information, and the like of the lesion candidate may be controlled by the diagnostic support unit 14. One or more of the information may be displayed on the display unit 30 together with the additional image. In addition, the diagnostic support unit 14 may transmit, to the image acquisition unit 12, a signal requesting the additional image with respect to a detected lesion candidate. In an example implementation, the diagnostic support unit 14 may have the configuration of an apparatus for facilitating lesion diagnosis illustrated in FIG. 2. The lesion diagnostic apparatus illustrated in FIG. 2 is described below in detail.

The diagnostic unit 16 may provide a diagnosis of a lesion based on the image acquired by the image acquisition unit 12 and lesion-related information provided from the diagnostic support unit 14. For example, using the additional image with respect to each of the lesion candidates detected by the diagnostic support unit 14, the diagnostic unit 16 may determine whether a corresponding lesion candidate corresponds to an actual lesion, and may provide an initial diagnosis of a disease when the corresponding lesion candidate corresponds to an actual lesion. Such initial diagnosis can facilitate an examinant such as a physician to accurately and efficiently diagnose a lesion. In this instance, the diagnostic unit 16 may sequentially analyze the lesion candidates in accordance with the movement path between the lesion candidates that are provided by the diagnostic support unit 14.

There is no limitation on a specific algorithm that may be used to diagnose lesions using the additional image of each of the lesion candidates by the diagnostic unit 16. For example, the diagnostic unit 16 may use lesion information such as feature information about a lesion image of a lesion candidate that is acquired from the additional image, and/or feature information about a lesion contour. As an example of the feature information about the lesion image, shape information of the lesion image included in the additional image, orientation information of the lesion image, contour information of the lesion image, and/or uniformity information of the lesion image may be given.

For example, in a case of a breast examination, the feature information about the lesion image may be information used in a Breast Imaging-Reporting And Data System (BI-RADS). As examples of the feature information about the lesion contour, similarity information between perimetric contours, and area information, center information, peripheral information, lateral is length information, vertical length information, longest axis length information, and/or shortest axis length information of the lesion contour may be provided.

FIG. 2 is a diagram illustrating a configuration of an example of an apparatus that facilitates lesion diagnosis. The apparatus 100 for facilitating lesion diagnosis of FIG. 2 is an apparatus for diagnosing lesions in accordance with a predetermined algorithm using an image of a specific region of a human body photographed using the medical imaging apparatus. Referring to FIG. 2, the apparatus 100 for facilitating lesion diagnosis includes a candidate detection unit 110, a calculation unit 120, and a control unit 130. The apparatus 100 for facilitating lesion diagnosis illustrated in FIG. 2 may be a diagnostic support unit 14 that is provided in the lesion diagnostic apparatus 10, for example, as illustrated in FIG. 1. However, various modifications may be made in other examples.

The candidate detection unit 110 detects lesion candidates using a 3D volume image with respect to a specific region acquired by an image acquisition unit 12 illustrated, for example, in FIG. 1. A “lesion candidate” is a region of the examined region of the body that has a high possibility of being determined as a lesion in the 3D volume image, and/or a region that is predicted as a region having a high possibility of having a lesion based on existing statistical data.

There is no limitation on a specific algorithm for detecting the lesion candidates from the 3D volume image. For example, in order to detect an exact lesion candidate, a contour of the lesion included in 2D image frames constituting the 3D volume image that is a 3D image may be extracted. For instance, an image segmentation may be executed with respect to the 2D image frames to analyze a corresponding image; the contour of the lesion included in the 2D image frames may be extracted from the analysis. The contour of the lesion may be three-dimensionally specified in the 3D volume image by combining the extracted contours of the lesion; in this manner, a region in which the contour is specified may be the lesion candidate.

The candidate detection unit 110 may generate lesion candidate information of each of is the extracted lesion candidates, and may transmit the generated information to the calculation unit 120. The lesion candidate information generated by the candidate detection unit 110 may include position information about the lesion candidate. The position information about the lesion candidate may be displayed with a variety of methods. For example, the position information may be displayed as vector coordinates with respect to a setting position such as an upper left corner or a center of a screen, or the like, or may be displayed as vector coordinates with respect to a feature point in a region of a human body that is irradiated, such as, for example, a nipple location in a case of a breast, etc.

The lesion candidate information may include characteristic information of a corresponding lesion candidate. The characteristic information of the lesion candidate may include feature information about the lesion image. As examples of the feature information of the lesion image, shape information of a lesion image included in a target image frame, orientation information of the lesion image, contour information of the lesion image, and/or uniformity information of the lesion image may be given.

The lesion candidates acquired by the candidate detection unit 110 may be primarily detected using the 3D volume image, and may be added in a diagnostic process that is subsequently performed. As an example of the latter, the lesion candidates may be additionally detected in a reviewing process of the 3D volume image, a process of re-scanning the diagnostic region, or a process of performing lesion diagnosis using the additional image, and the like acquired from a detailed diagnostic process that is subsequently performed. The candidate detection unit 110 may generate lesion candidate information even with respect to the lesion candidates that are additionally acquired. For example, the candidate detection unit 110 may generate lesion candidate information such as lesion candidate position information and characteristic information of a lesion candidate additionally acquired and may thereby transmit the generated information to the calculation unit 120.

The calculation unit 120 calculates a movement path between lesion candidates on which lesion diagnosis is to be performed by the diagnostic unit 16 (see FIG. 1) using the lesion candidate information transmitted from the candidate detection unit 110. The diagnostic unit 16 may sequentially acquire an additional image along the movement path received from the calculation unit 120 to thereby perform lesion diagnosis with respect to a corresponding lesion candidate. As described above, the additional image is an image which is useful for performing precise examination in comparison with the 3D volume image, and may include, for example, an MPR image, an out-focused image, a 2D ultrasound image photographed at a variety of angles, and the like. In this manner, the lesion candidates may be first detected by the candidate detection unit 110, and the movement path between the lesion candidates may be calculated by the calculation unit 120 using the detected lesion candidates. Additional images may be obtained along the movement path to allow the diagnostic unit 16 to thereby perform diagnosis. Accordingly, diagnosis may be performed with respect to all of the lesion candidates without missing any one of the lesion candidates.

A method of determining the movement path between a plurality of lesion candidates by the calculation unit 120 may be performed based on a malignancy level of each of the plurality of lesion candidates. In this example, the malignancy level may indicate a statistical probability in which each of the plurality of lesion candidates may correspond to an actual disease such as, for example, a malignant tumor. Such a malignancy level may be calculated by integrating lesion candidate image characteristics, such as a degree to which image characteristics of the lesion candidate acquired through the 3D volume image is similar to image characteristics of an actual lesion, in each of the lesion candidates. There is no limitation on the specific algorithm that may be used to make such a determination.

For example, the calculation unit 120 may calculate the movement path using characteristic information of the lesion candidate included in the lesion candidate information is that is transmitted from the image acquisition unit 110. The characteristic information of the lesion candidate may be shape information, orientation information, contour information, and/or uniformity information of a lesion candidate image, and the like, and the calculation unit 120 may calculate a malignancy level of a corresponding lesion candidate by integrating the characteristic information of the lesion candidates.

Another method of determining the movement path between the plurality of lesion candidates may be performed based on efficiency of lesion diagnosis. As described above, the movement path calculated by the calculation unit 120 may be utilized to obtain an additional image for a corresponding lesion candidate for the purpose of accurate lesion diagnosis. Accordingly, when the movement path is determined so that a moving distance of a probe of the medical imaging apparatus 20 (see FIG. 1) to acquire the additional image is the shortest, lesion diagnosis may be more effectively performed by the diagnostic unit 16 (see FIG. 1). Such a method may be particularly effectively applied to, for example, a case in which malignancy levels of the detected lesion candidates are all less than or equal to a reference value. However, various other methods may be used to determine the movement path.

The control unit 130 may control the lesion diagnostic apparatus 100 so as to sequentially acquire additional images with respect to the lesion candidates along the movement path calculated by the calculation unit 120. For example, the control unit 130 may generate an additional image acquisition request signal requesting acquisition of the additional image with respect to each of the lesion candidates, and the generated additional image acquisition request signal may be transmitted to the image acquisition unit 12 (see FIG. 1). The additional image acquisition request signal may include position information of a corresponding lesion candidate.

The control unit 130 may control the lesion diagnostic apparatus 100 such that the calculated information generated in the calculation unit 120 is displayed on the display unit 30 (see FIG. 1). The calculated information may include the movement path, the malignancy level information, and the like. The control unit 130 may control the lesion diagnostic apparatus 100 such that visiting frequency information, diagnostic result information, and the like as well as calculated base information other than the calculated information, such as, for example, determination base information of a malignancy level as the characteristic information of the lesion candidate, are displayed on the display unit 30. The control unit 130 may control the lesion diagnostic apparatus 100 such that the calculated information and the other additional information are displayed on the display unit 30 in accordance with a setting of the lesion diagnostic apparatus 100, and also such that corresponding information is displayed on the display unit 30 by an On/Off selection of a user.

For example, the control unit 130 may control the lesion diagnostic apparatus 100 such that movement path information generated in the calculation unit 120 is displayed on the display unit 30. In this instance, a relative position and/or direction of each of the lesion candidates may be displayed with respect to a current image acquisition position such as, for example, a current position of the probe or a center position of an image, or another reference position. The relative position and/or direction may be displayed using coordinates or vectors, or may be displayed by graphics. The graphics are not limited to a top view, and may be displayed as a plane view or a multi-view in a predetermined direction, which can effectively show the movement path.

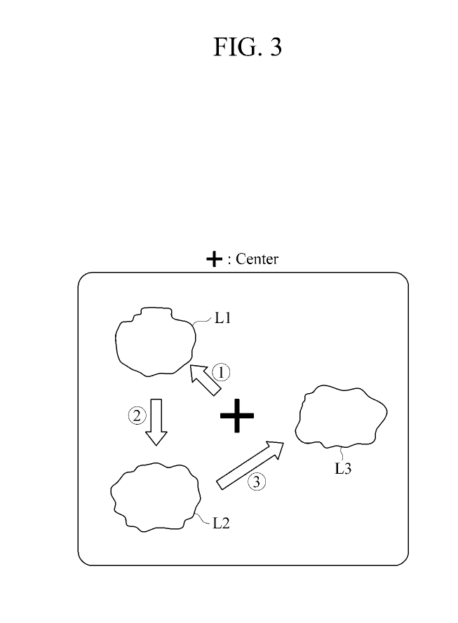

FIG. 3 is a diagram illustrating an example of a movement path between a plurality of lesion candidates that may be displayed on a display unit. In FIG. 3, a position represented as a cross is an example of a reference position. In this example, a center of an image is used as the reference position. Referring to FIG. 3, three lesion candidates L1, L2, and L3 are present within the image. As an example, a movement path between the lesion candidates L1, L2, and L3 may be displayed using arrows and/or numbers. In cases of using arrows, the ranking may be displayed using numbers, or by differentiating between arrows by using a variety of colors, brightness such as various gray levels, or the like.

The control unit 130 may digitize information about each of the lesion candidates L1, L2, and L3 as shown in FIG. 3 to thereby display the digitized information on the display. For instance, the lesion candidates L1, L2, and L3 may be sequentially listed along the movement path.

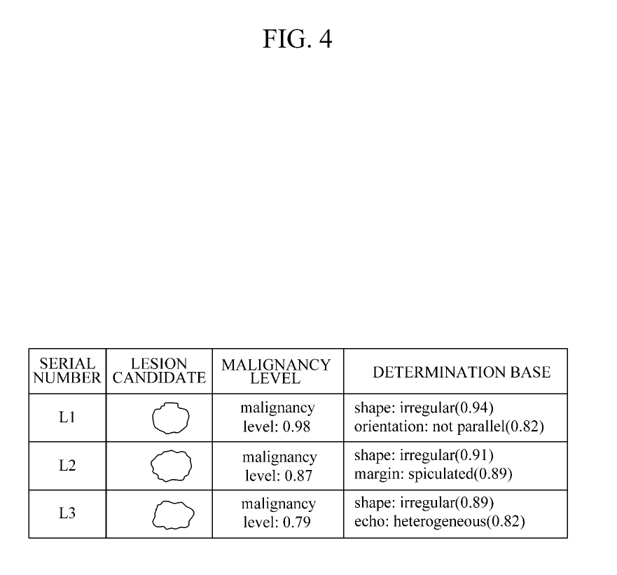

FIG. 4 is a diagram illustrating an example of a method of digitizing and displaying information about each of the lesion candidates L1, L2, and L3. Referring to FIG. 4, the information about the lesion candidates L1, L2, and L3 may include image information, malignancy level information, and/or determination base information of a corresponding lesion as well as ranking information in accordance with the movement path.

The information about the lesion candidates L1, L2, and L3 listed in FIG. 4 may be displayed on a separate display region from a lesion image on one or more display unit. Such information may be displayed in such a manner that the information may be turned On/Off by a user's operation. In addition, a type of information displayed on the display unit in an initial environment setting or in a default setting may be set by a user.

The movement path between the lesion candidates L1, L2, and L3 displayed on a display unit illustrated in FIG. 3, and/or numerical information about each of the lesion candidates L1, L2, and L3 shown in FIG. 4 may be utilized to automatically display an additional image with respect to the lesion candidate, for example, an MPR image. For example, when a specific lesion candidate displayed on a display unit is selected by a user, the control unit 130 may control the MPR image with respect to the selected lesion candidate to be displayed on the display unit. For example, an existing screen may be replaced by the MPR image so that the MPR image is displayed, or the MPR image may be displayed on a separate display region. The MPR image displayed on the display unit may include a plane view selected by a user, as is well as an axial view, a sagittal view, and a coronal view. Such an additional image may be turned On/Off by the selection of the user.

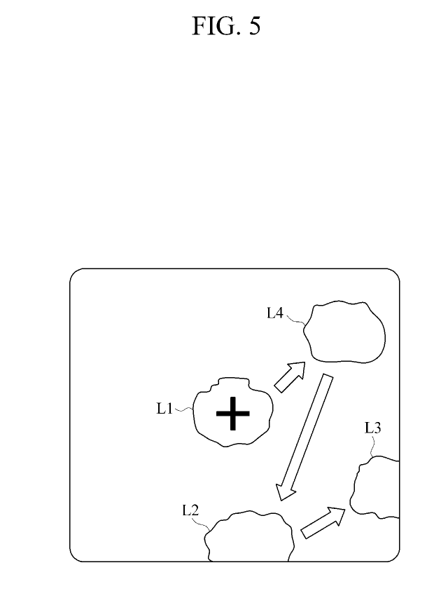

As described above, the lesion candidates detected by the candidate detection unit 110 may be added in a diagnostic process. When the lesion candidates are added, an existing movement path between the lesion candidates may be changed so that the added lesion candidate is included in the existing movement path, or the added lesion candidate may be disposed at the end of the movement path. FIG. 5 is a diagram illustrating an example in which a new lesion candidate L4 is subsequently added to the lesion candidates of FIG. 3, and the movement path between the lesion candidates L1 to L4 is changed due to the addition. Referring to FIG. 5, it has been found that the movement path is changed so that the added lesion candidate L4 is positioned between the lesion candidate L1 and the lesion candidate L3 due to a detection order of the lesion candidate L4.

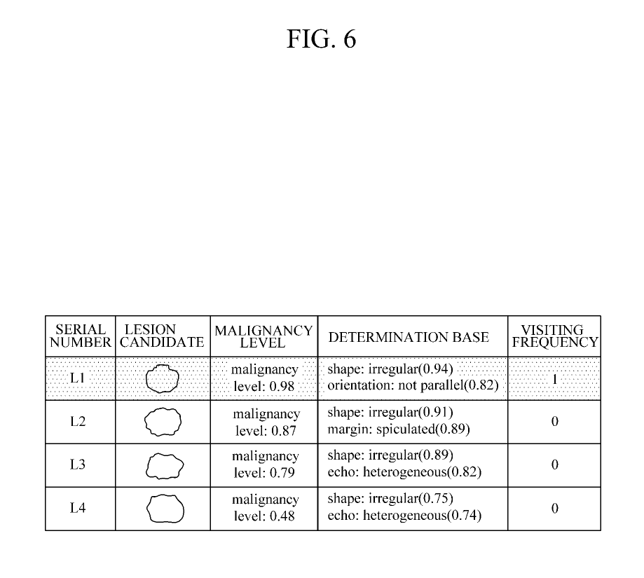

Lesion candidate information about the lesion candidate L4 that is additionally detected may also be added to lesion candidate information about the existing lesion candidates L1, L2, and L3. FIG. 6 is a diagram illustrating an example in which the lesion candidate information of the lesion candidate L4, which is additionally detected, is added to the lesion candidate information about the existing lesion candidates, and displayed on a display unit. Referring to FIG. 6, it has been found that lesion candidate information of the lesion candidate L4, which has been detected in addition to the existing lesion candidates L1, L2, and L3, is included. In addition, the lesion candidate information illustrated in FIG. 6 includes visiting frequency information about each of the lesion candidates L1 to L4 in addition to the lesion candidate information shown in FIG. 4. As can be seen from FIG. 6, the lesion candidate L1 that is visited by an examinant may be displayed so as to be visually distinguished from the lesion candidates L2 to L4 that are not visited by the examinant.

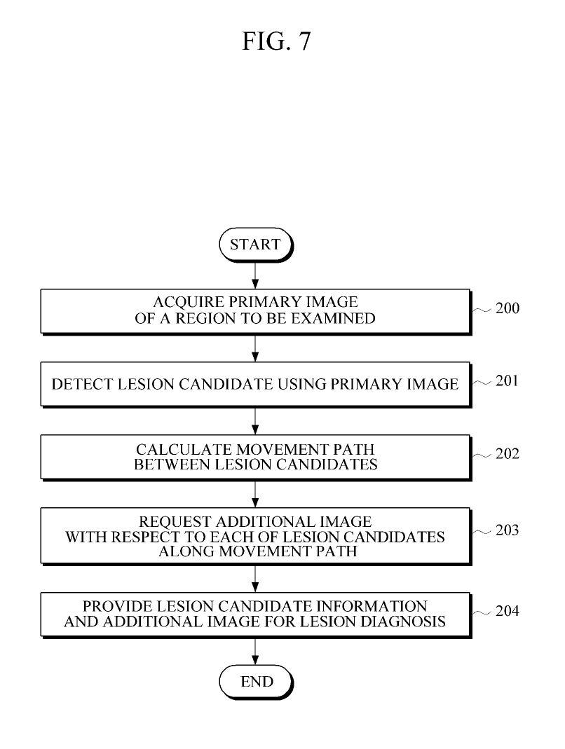

FIG. 7 is a flowchart illustrating an example of a method of facilitating lesion diagnosis. Hereinafter, to avoid unnecessary repeated descriptions of the above described apparatus for facilitating lesion diagnosis 100 (see FIG. 2), the method of facilitating lesion diagnosis will be briefly described. The above descriptions of the apparatus for facilitating lesion diagnosis according to various examples apply to methods of facilitating lesion diagnosis, and are therefore not repeated here.

Referring to FIG. 7, first, in 200, a primary image of an entire region to be examined on which lesion diagnosis is to be performed is acquired. Here, the “primary image” is an image that is primarily acquired with respect to the entire region to be examined, and the primary image may be a “3D volume image” like those described above. There is no limitation on the type of primary image, as long as the primary image is used to detect the lesion candidate to acquire an additional image that is an improved image for accurate lesion diagnosis.

In 201, a lesion candidate is detected using the acquired primary image. The “lesion candidate” is a region of the examined region that has a high possibility of being determined as a lesion through analyzing the primary image. Such a “lesion candidate” may be a region that is predicted as having a high possibility of having a lesion based on existing statistical data, for example. However, there is no limitation on a specific algorithm which detects the lesion candidate.

In 202, when the lesion candidate is detected, a movement path between a plurality of lesion candidates is calculated. The movement path indicates a sequence for performing the lesion diagnosis with respect to each of the plurality of lesion candidates by acquiring an additional image. Such a movement path may be determined by a malignancy level which is determined based on characteristic information of a lesion candidate such as shape information, orientation information, contour information, and/or uniformity information of a lesion candidate image, or may be determined based on efficiency of examination, for example by minimizing a moving distance. Various other methods may be used to determine the movement path in other examples.

In 203, acquisition of the additional image with respect to each of the lesion candidates is requested along the movement path. The additional image is an improved image compared to the primary image. For example, the additional image may be an image used to perform accurate lesion diagnosis with respect to the lesion candidate. For example, the additional image may include an MPR image with respect to the lesion candidate, a planar image that is cut at a predetermined angle, and/or an image having improved image quality that is acquired by adjusting a focus of a photographing device. In a method of facilitating lesion diagnosis, acquisitions of the additional images are sequentially requested along the movement path that is determined in advance. Therefore, lesion diagnosis may be performed with respect to all of the lesion candidates without missing any one of the lesion candidates.

Subsequently, in 204, when the additional image with respect to the lesion candidate is acquired in response to the acquisition request of the additional image in 203, the acquired additional image is provided for lesion diagnosis. In this instance, in addition to the additional image, information that is generated in a process of detecting the lesion candidate in 201 or in a process of calculating the movement path in 202, or information (for example, malignancy level determination base information) used for the above information, and the like may also be provided for lesion diagnosis.

Although not shown in FIG. 7, a variety of information which is generated in a method of facilitating lesion diagnosis may be displayed on a display unit for a user such as a lesion examinant. For example, the movement path between the lesion candidates calculated in 202 may be displayed on the display unit in a format such as a graphic, a list and/or a table. For instance, information about each of the lesion candidates, such as image information, malignancy is level information, malignancy level calculation base information, visiting frequency information, diagnostic result information, and the like, may be displayed together on the display unit. When a variety of information about the lesion candidates is displayed on the display unit, accurate diagnosis with respect to the lesion may be more effectively performed by a user without missing any one of the lesion candidates.

A display unit includes any device that allows visualization of information to a user. Examples of a display unit include a monitor, an LCD device, an LED device, an LCD screen, an LED screen, a projection apparatus, a screen mounted or embedded in a wall, etc. The display unit may output the image to a fixable medium such as a paper or a board. The display unit may also allow input from a user. For example, a display unit may be a touch screen that displays visual information and allows a user to provide an input.

Units and apparatuses described herein may be implemented using hardware components and software components. For example, a unit or an apparatus may be implemented with a processing device. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

The software component of the above described method may be performed on a computer. The software component may include a computer program, a piece of code, an instruction, or some combination thereof, for independently or collectively instructing or configuring the processing device or a processor to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, diagrams, functional programs, codes, and code segments for accomplishing the examples disclosed herein can be easily construed by programmers skilled in the art to which the examples pertain based on and using the flow diagram and schematic diagrams provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for facilitating lesion diagnosis, comprising:
a candidate detection unit configured to detect one or more lesion candidate using a primary image of a body region;
a calculation unit configured to calculate a movement path corresponding to a sequence for analyzing the one or more lesion candidate; and
a control unit configured to request an additional image with respect to the one or more lesion candidate along the movement path.

2. The apparatus according to claim 1, wherein the calculation unit is configured to determine the movement path based on a malignancy level of each of the one or more lesion candidate.

3. The apparatus according to claim 2, wherein the malignancy level is calculated based on image shape information, image orientation information, image contour information, or image uniformity information of each of the one or more lesion candidate.

4. The apparatus according to claim 1, wherein the calculation unit is configured to determine the movement path so that a moving distance is shortest when acquiring the additional image.

5. The apparatus according to claim 1, wherein the control unit is configured to control the movement path to be displayed on a display unit.

6. The apparatus according to claim 5, wherein the control unit is configured to control the movement path so that lesion candidate related information including malignancy level information, malignancy level determination base information, visiting frequency information or a combination thereof is displayed on the display unit.

7. The apparatus according to claim 1, wherein the additional image is an improved image of the primary image.

8. The apparatus according to claim 1, wherein the additional image includes a multi-planar reconstruction (MPR) image.

9. The apparatus according to claim 8, wherein the additional image further includes either an image obtained by cutting a lesion candidate along a plane at an angle, or an image in is which a focal point is aligned with a lesion candidate.

10. A method of facilitating lesion diagnosis, comprising:
acquiring a primary image of a body region;
detecting one or more lesion candidate using the primary image;
calculating a movement path corresponding to a sequence for analyzing the lesion candidates; and
requesting an additional image with respect to the lesion candidates along the movement path.

11. The method according to claim 10, wherein the calculating determines the movement path based on a malignancy level of each of the one or more lesion candidate.

12. The method according to claim 11, wherein the malignancy level is calculated based on image shape information, image orientation information, image contour information, or image uniformity information of each of the one or more lesion candidate.

13. The method according to claim 10, wherein the calculating determines the movement path so that a moving distance is shortest when acquiring the additional image.

14. The method according to claim 10, further comprising:
controlling the movement path to be displayed on a display unit.

15. The method according to claim 14, wherein the controlling includes controlling the is movement path so that lesion candidate related information including malignancy level information, malignancy level determination base information, visiting frequency information of the lesion candidate, or a combination thereof is displayed on the display unit.

16. The method according to claim 10, wherein the additional image is an improved image of the primary image.

17. The method according to claim 10, wherein the additional image includes a multi-planar reconstruction (MPR) image.

18. The method according to claim 17, wherein the additional image further includes either an image obtained by cutting a lesion candidate along a plane of a selected angle, or an image in which a focal point is aligned with a lesion candidate.

19. An apparatus for facilitating lesion diagnosis, comprising:
a processor configured to analyze an image of a body region, detect one or more lesion candidate from the image, and obtain an additional image of at least one of the one or more lesion candidate; and
a display unit configured to display at least one of the one or more lesion candidate,
wherein the processor is configured to perform an initial diagnosis of at least one of the one or more lesion candidate.

20. The apparatus of claim 19, wherein the processor is configured to perform an initial diagnosis based on a degree to which the additional image has characteristics of an actual lesion.

21. The apparatus of claim 20, wherein the processor is configured to perform an initial diagnosis of a tumor based on whether the additional image has characteristics exhibited by a malignant tumor, and, in an event that a lesion candidate is determined to include a tumor, the display unit is configured to display the lesion candidate corresponding to the tumor.

22. The apparatus of claim 19, wherein the processor is configured to detect the one or more lesion candidate from the image of the body region based on a probability that a region contains a lesion based on statistical data.

23. The apparatus of claim 19, wherein the processor is configured to calculate a movement path corresponding to a sequence for analyzing the one or more lesion candidate and to obtain the additional image with respect to at least one of the one or more lesion candidate along the movement path.
